(19) United States
(12) Patent Application Publication
(10) Pub. No.: US 2024/0104774 A1
(43) Pub. Date: Mar. 28, 2024

(54) Multi-dimensional Object Pose Estimation and Refinement

(71) Applicant: Siemens Aktiengesellschaft, München (DE)

(72) Inventors: Slobodan Ilic, München (DE); Ivan Shugurov, München (DE); Sergey Zakharov, San Francisco, CA (US); Ivan Pavlov, München (DE)

(73) Assignee: Siemens Aktiengesellschaft, München (DE)

(21) Appl. No.: 18/257,091

(22) PCT Filed: Dec. 9, 2021
(86) PCT No.: PCT/EP2021/085043

§ 371 Date: Jun. 13, 2023

(30) Foreign Application Priority Data
Dec. 18, 2020 (DE) 10 2020 216 331.6

(51) Int. Cl. G06T 7/73; G06T 7/12; G06T 17/00

(52) U.S. Cl. CPC G06T 7/75; G06T 7/12; G06T 17/00

(57) ABSTRACT

Various embodiments include a pose estimation method for refining an initial multi-dimensional pose of an object of interest to generate a refined multi-dimensional object pose Tₚᵣ(NL) with NL≥1. The method may include: providing the initial object pose Tₚᵣ(0) and at least one 2D-3D-correspondence map Ψprⁱ with i=1, . . . , I and I≥1; and estimating the refined object pose Tₚᵣ(NL) using an iterative optimization procedure of a loss according to a given loss function LF(k) based on discrepancies between the one or more provided 2D-3D-correspondence maps Ψₚᵣⁱ and one or more respective rendered 2D-3D-correspondence maps Ψ_{rend}^{k,i}.

### CROSS-REFERENCE TO RELATED APPLICATIONS

This application is a U.S. National Stage Application of International Application No. PCT/EP2021/085043 filed Dec. 9, 2021, which designates the United States of America, and claims priority to DE Application No. 10 2020 216 331.6 filed Dec. 18, 2020, the contents of which are hereby incorporated by reference in their entirety.

### TECHNICAL FIELD

The present disclosure relates to the estimation and especially for the refinement of an estimated pose of an object of interest in a plurality of dimensions.

### BACKGROUND

Object detection and multi-dimensional pose estimation of the detected object are regularly addressed in computer vision since they are applicable in a wide range of applications in different domains. Just for example, autonomous driving, augmented reality, and robotics are hardly possible without fast and precise object localization in 2D and 3D. A large body of work has been invested in the past, but recent advances in deep learning opened new horizons for RGB-based approaches (red-green-blue) which started to dominate the field. Often, RGB images and corresponding depth data are utilized to determine poses. Current state-of-the-art utilizes deep learning methods in connection with the RGB images and depth information. Thus, artificial neural networks are often applied to estimate a pose of an object in a scene based on images of that object from different perspectives and based on a comprehensive data base.

However, such approaches are often time consuming and, especially, a suitable data base with a sufficient amount of labeled training data in a comprehensive variety which allows the accurate detection of a wide range of objects is hardly available.

Thus, multi-dimensional pose estimation, in the best case covering six degrees of freedom (6DoF), from monocular RGB images still remains a challenging problem. Methods for coarse estimation of such poses are available, but the accuracy is often not sufficient for industrial applications.

### SUMMARY

Therefore, the teachings of the present disclosure serve the need to determine an exact multi-dimensional pose of an object of interest. For example, some embodiments include a A computer implemented pose estimation method PEM for refining an initial multi-dimensional pose Tₚᵣ(0) of an object of interest OBJ to generate a refined multi-dimensional object pose Tₚᵣ(NL) with NL≥1, including providing the initial object pose Tₚᵣ(0) and at least one 2D-3D-correspondence map Tₚᵣ with i=1, . . . , I and I≥1, and estimating the refined object pose Ψₚᵣ(NL) by an iterative optimization procedure IOP of a loss according to a given loss function LF(k) and depending on discrepancies between the one or more provided 2D-3D-correspondence maps Ψₚᵣⁱ and one or more respective rendered 2D-3D-correspondence maps Ψ_{rend}^{k,i}.

In some embodiments, the loss function LF is defined as a per-pixel loss function over provided correspondence maps Ψₚᵣⁱ and rendered correspondence maps Ψ_{rend}^{k,i}, wherein the loss function LF(k) relates the per-pixel discrepancies of provided correspondence maps Ψₚᵣⁱ and respective rendered correspondence maps Ψ_{rend}^{k,i} to the 3D structure of the object and its pose Tₚᵣ(k), wherein the rendered correspondence maps Ψ_{rend}^{k,i} depend on an assumed object pose Tₚᵣ(k) and the assumed object pose Tₚᵣ(k) is varied in the loops k of the iterative optimization procedure.

In some embodiments, the iterative optimization procedure IOP of step S2 comprises NL≥1 iteration loops k with k=1, . . . , NL, wherein in each iteration loop k, an object pose Tₚᵣ(k) is assumed, a renderer dREND renders one respective 2D-3D-correspondence map Ψ_{rend}^{k,i} for each provided 2D-3D-correspondence map Ψₚᵣⁱ, utilizing as an input: a 3D model MODOBJ of the object of interest OBJ, the assumed object pose Tₚᵣ(k), and an imaging parameter PARA(i) which represents one or more parameters of capturing an image IMA(i) underlying the respective provided 2D-3D-correspondence map Ψₚᵣⁱ.

In some embodiments, the assumed object pose Tₚᵣ(k) of loop k of the iterative optimization procedure IOP is selected such that Tₚᵣ(k) differs from the assumed object pose Tₚᵣ(k−1) of the preceding loop k−1, wherein the iterative optimization procedure applies a gradient-based method for the selection, wherein the loss function LF is minimized in terms of object pose updates ΔT, such that Tₚᵣ(k)=ΔT·Tₚᵣ(k−1).

In some embodiments, in each iteration loop k a segmentation mask SEG_{rend}(k, i) is obtained by the renderer dREND for each one of the respective rendered 2D-3D-correspondence maps Ψ_{rend}^{k,i}, which segmentation masks SEG_{rend}(k, i) correspond to the object of interest OBJ in the assumed object pose Tₚᵣ(k), wherein each segmentation mask SEG_{rend}(k, i) is obtained by rendering the 3D model MODOBJ using the assumed object pose Tₚᵣ(k) and imaging parameter PARA(i).

In some embodiments, the loss function LF(k) is defined as a per pixel loss function in a loop k of the iterative optimization procedure IOP, wherein

$$LF ( k ) = \frac{1}{I} {\sum }_{i = 1}^{I} L ( {T}_{pr} ( k ) , {SEG}_{pr} ( i ) , {SEG}_{rend} ( k , i ) , {Ψ}_{pr}^{i} , {Ψ}_{rend}^{k , i} )$$

$$with$$

$$L ( {T}_{pr} ( k ) , {SEG}_{pr} ( i ) , {SEG}_{rend} ( k , i ) , {Ψ}_{pr}^{i} , {Ψ}_{rend}^{k , i} ) = \frac{1}{N} {\sum }_{( x , y ) ∈ {SEG}_{pr} ( i ) ⋂ {SEG}_{rend} ( k , i )} ρ ( {π}_{ℳ}^{- 1} ( {Ψ}_{pr}^{i} ( x , y ) ) , {π}_{ℳ}^{- 1} ( {Ψ}_{rend}^{k , i} ( x , y ) ) )$$

and wherein: I expresses the number of provided 2D-3D-correspondence maps Ψₚᵣⁱ, x, y are pixel coordinates in the correspondence maps Ψₚᵣⁱ, Ψ_{rend}^{k,i}, ρ stands for a distance function in 3D, SEGₚᵣ(i)∩SEG_{rend}(k, i) is the group of intersecting points of predicted and rendered correspondence maps Ψₚᵣⁱ, Ψ_{rend}^{k,i}, expressed by the corresponding segmentation masks SEGₚᵣ(i), SEG_{rend}(k, i), N is the number of such intersecting points of predicted and rendered correspondence maps end Ψₚᵣⁱ, Ψ_{rend}^{k,i}, and [symbol] is an operator for transformation of the respective argument into a suitable coordinate system.

In some embodiments, the renderer dREND is a differentiable renderer.

In some embodiments, in a step 50 for the determination of the initial object pose Tₚᵣ(0) of the object of interest OBJ to be provided in the first step S1, a number I of images IMA(i) of the object of interest OBJ with i=1, . . . , I and I≥2 as well as known imaging parameters PARA(i) are provided, wherein different images IMA(i) are characterized by different imaging parameters PARA(i), the provided images IMA(i) are processed in a determination step DCS to determine for each image IMA(i) a respective 2D-3D-correspondence map Ψₚᵣⁱ as well as a respective segmentation mask SEGₚᵣ(i), and at least one of the 2D-3D-correspondence maps Ψₚᵣⁱ is further processed in a coarse pose estimation step CPES to determine the initial object pose Tₚᵣ(0).

In some embodiments, one of the plurality J of the 2D-3D-correspondence maps Ψₚᵣ^{j} with j=1, . . . , J and I≥J≥2 is processed in the coarse pose estimation step CPES to determine the initial object pose Tₚᵣ(0).

In some embodiments, each one j of a plurality J of the 2D-3D-correspondence maps Ψₚᵣ^{j} with j=1, . . . , J and I≥J≥2 is processed in the coarse pose estimation step CPES to determine a respective preliminary object pose T_{pr,j}(0), wherein the initial object pose Tₚᵣ(0) represents an average of the preliminary object poses T_{pr,j}(0).

In some embodiments, a dense pose object detector DPOD which is embodied as a trained artificial neural network is applied in the preparation step PS to determine the 2D-3D-correspondence maps Ψₚᵣⁱ and the segmentation masks SEGₚᵣ(i) from the respective images IMA (i).

In some embodiments, the coarse pose estimation step CPES applies a Perspective-n-Point approach (PnP), especially supplemented by a random sample consensus approach (RANSAC), to determine a respective object pose Tₚᵣ(0), T_{pr,j}(0) from the at least one 2D-3D-correspondence map Ψₚᵣⁱ, Ψₚᵣ^{j}.

As another example, some embodiments include a pose estimation system (100) for refining an initial multi-dimensional pose Tₚᵣ(0) of an object of interest OBJ to generate a refined multi-dimensional object pose Tₚᵣ(NL) with NL≥1, including a control system (120) configured for executing one or more of the pose estimation methods PEM described herein.

### BRIEF DESCRIPTION OF THE DRAWINGS

In the following, example embodiments of the teachings of the present disclosure are described in more detail with reference to the enclosed figures. The objects as well as further advantages of the present embodiments are more apparent and readily appreciated from the following description of the example embodiments, taken in conjunction with the accompanying figure in which:

FIG. 1 shows a real world scene with an object of interest;

FIG. 2 an example pose estimation method incorporating teachings of the present disclosure;

FIG. 3 an initial pose estimation procedure incorporating teachings of the present disclosure; and

FIG. 4 a pose refinement procedure incorporating teachings of the present disclosure.

### DETAILED DESCRIPTION

Some embodiments of the teachings herein include a computer implemented pose estimation method PEM which refines an initial multi-dimensional pose Tₚᵣ(0) of an object of interest OBJ and generates a refined multi-dimensional object pose Tₚᵣ(NL) with NL≥1. In some embodiments, the method includes providing the initial object pose Tₚᵣ(0) and at least one 2D-3D-correspondence map Ψₚᵣⁱ with i=1, . . . , I and I≥1. In some embodiments, the method includes estimating the refined object pose Tₚᵣ(NL), including an iterative optimization, i.e. minimization, procedure IOP comprising a number NL of loops k=1, . . . , NL of a loss is applied, the loss according to a given loss function LF(k) and depending on discrepancies between the one or more provided 2D-3D-correspondence maps Ψₚᵣⁱ and one or more respective rendered 2D-3D-correspondence maps Ψ_{rend}^{k,i}.

The 6DoF pose estimation first utilizes a predicted initial pose Tₚᵣ(0). The initial predicted pose Tₚᵣ(0) is then refined in NL≥1 iterations and loops k, so that in the end a refined pose Tₚᵣ(k=NL) is available. The pose refinement is based on an optimization of the discrepancy between provided correspondence maps Ψₚᵣⁱ and related rendered correspondence map Ψ_{rend}^{k,i} for each i. The rendered correspondence maps Ψ_{rend}^{k,i} and, correspondingly, the discrepancy directly depend on the assumed object pose Tₚᵣ(k) so that a variation of the object pose Tₚᵣ(k) leads to a variation of the discrepancy, such that a minimum discrepancy can be considered to be an indicator for correctness of the assumed object pose Tₚᵣ(NL).

The loss function LF is defined as a per-pixel loss function over provided correspondence maps Ψₚᵣⁱ and rendered correspondence maps Ψ_{rend}^{k,i}, wherein the loss function LF(k) relates the per-pixel discrepancies of provided correspondence maps Ψₚᵣⁱ and respective rendered correspondence maps Ψ_{rend}^{k,i} to the 3D structure of the object and its pose Tₚᵣ(k), wherein the rendered correspondence maps Ψ_{rend}^{k,i} and, therewith, the loss function LF(k) depend on an assumed object pose Tₚᵣ(k) and the assumed object pose Tₚᵣ(k) is varied in the loops k of the iterative optimization procedure.

The iterative optimization procedure IOP of step S2 comprises NL≥1 iteration loops k with k=1, . . . , NL. In each iteration loop k an object pose Tₚᵣ(k) is assumed and a renderer dREND renders one respective 2D-3D-correspondence map Ψ_{rend}^{k,i} of the one or more model 2D-3D-correspondence maps T_{rend}(k, i) for each provided 2D-3D-correspondence map Ψₚᵣⁱ. For that purpose, the renderer dREND utilizes as an input a 3D model MODOBJ of the object of interest OBJ, the assumed object pose Tₚᵣ(k), and an imaging parameter PARA(i) which represents one or more parameters of capturing an image IMA(i) underlying the respective provided 2D-3D-correspondence map Ψₚᵣⁱ.

Therein, the term “for” within the expression “for each provided 2D-3D-correspondence map Ψₚᵣⁱ” essentially represents that the provided 2D-3D-correspondence map Ψₚᵣⁱ and the respective rendered 2D-3D-correspondence map Ψ_{rend}^{k,i} are assigned to each other. Moreover, it expresses that the rendering of the “related” rendered 2D-3D-correspondence map Ψ_{rend}^{k,i} and the earlier capturing of the image IMA(i) underlying, i.e. being selected and used for, the determination of the provided 2D-3D-correspondence map Ψₚᵣⁱ utilize the same imaging parameters PARA(i).

In summary, given the 3D model, imaging parameters PARA(i) including, for example, the camera position POS(i) and corresponding intrinsic camera parameters CAM(i) applied for capturing the image IMA(i), as well as the assumed object pose Tₚᵣ(k), it is possible to compute which vertex of the 3D model MODOBJ would be projected on which pixel of a rendered 2D image IMA(i) and vice versa. This correspondence is expressed by a respective 2D-3D-correspondence map Ψ_{rend}^{k,i}. This process is deterministic and errorless. In some embodiments, a differentiable renderer is applied to achieve this and the resulting rendered correspondence map Ψ_{rend}^{k,i} corresponds to the 3D model in the given pose Tₚᵣ(k) from the perspective PER(i) of the respective camera position POS(i).

The iterative optimization procedure of step S2 ends at k=NL when the loss function LF converges or falls under a given threshold or similar. I.e. NL is not pre-defined but depends on the variation of Tₚᵣ(k) and the resulting outcome of the loss function LF. However, general criteria for ending an iterative optimization procedure of a loss function as such are well known from prior art and do not form an essential aspect of the invention.

The assumed object pose Tₚᵣ(k) of loop k of the iterative optimization procedure IOP is selected such that Tₚᵣ(k) differs from the assumed object pose T_{y}r (k−1) of the preceding loop k−1, wherein the iterative optimization procedure applies a gradient-based method for the selection, wherein the loss function LF is minimized in terms of object pose updates ΔT, such that Tₚᵣ(k)=ΔT·Tₚᵣ(k−1). I.e. the loss function LF is minimized iteratively by gradient descent over the object pose update ΔT. This could be done with any gradient-based methods, such as [Kingma2014].

Convergence might be achieved within, for example, 50 optimization steps, i.e. NL=50.

Furthermore, in each iteration loop k a segmentation mask SEG_{rend}(k, i) is obtained by the renderer dREND for each one of the respective rendered 2D-3D-correspondence maps Ψ_{rend}^{k,i}, which segmentation masks SEG_{rend}(k, i) correspond to the object of interest OBJ in the assumed object pose Tₚᵣ(k), wherein each segmentation mask SEG_{rend}(k, i) is obtained by rendering the 3D model MODOBJ using the assumed object pose Tₚᵣ(k) and imaging parameter PARA(i). The segmentation masks are binary masks, having pixel values “1” or “0”.

The loss function LF(k) can be defined as a per pixel loss function in a loop k of the iterative optimization procedure IOP, wherein

$$LF ( k ) = \frac{1}{I} {\sum }_{i = 1}^{I} L ( {T}_{pr} ( k ) , {SEG}_{pr} ( i ) , {SEG}_{rend} ( k , i ) , {Ψ}_{pr}^{i} , {Ψ}_{rend}^{k , i} )$$

$$with$$

$$L ( {T}_{pr} ( k ) , {SEG}_{pr} ( i ) , {SEG}_{rend} ( k , i ) , {Ψ}_{pr}^{i} , {Ψ}_{rend}^{k , i} ) = \frac{1}{N} {\sum }_{( x , y ) ∈ {SEG}_{pr} ( i ) ⋂ {SEG}_{rend} ( k , i )} ρ ( {π}_{ℳ}^{- 1} ( {Ψ}_{pr}^{i} ( x , y ) ) , {π}_{ℳ}^{- 1} ( {Ψ}_{rend}^{k , i} ( x , y ) ) )$$

and wherein
I expresses the number of provided 2D-3D-correspondence maps Ψₚᵣⁱ,
x, y are pixel coordinates in the correspondence maps Ψₚᵣⁱ, Ψ_{rend}^{k,i},
ρ stands for an arbitrary distance function in 3D,
SEG_{Pr}(i)∩SEG_{rend}(k, i) is the group of intersecting points of predicted and rendered correspondence maps Ψₚᵣⁱ, Ψ_{rend}^{k,i}, expressed by the corresponding segmentation masks SEGₚᵣ(i), SEG_{rend}(k, i),
N is the number of such intersecting points of predicted and rendered correspondence maps Ψₚᵣⁱ, Ψ_{rend}^{k,i}, expressed by the corresponding segmentation masks SEGₚᵣ(i), SEG_{rend}(k, i),
[symbol] is an operator for transformation of the respective argument into a suitable coordinate system, [symbol] can be the inverse of a “NOCS” operator.

In some embodiments, the renderer dREND is a differentiable renderer. Therein, a differentiable renderer is a differentiable implementation of a standard renderer, e.g. known from computer graphics applications. For example, such differentiable renderer takes a textured object model, an object's pose, light courses, etc. and produces a corresponding image. In contrast to standard rendering, a differentiable renderer allows to define any function over the image and to compute its derivatives w.r.t. all the renderer inputs, e.g. a textured object model, an object's pose, light courses, etc. as mentioned above. In such a way, it is possible to directly update the object, its colors, its position, etc. in order to get the desired rendered image.

The initial object pose Tₚᵣ(0) to be provided in the first step S1 can be determined in a step S0, which is, consequently, executed before step S1. In the step S0, a number I of images IMA(i) of the object of interest OBJ with i=1, . . . , I and I≥2 as well as known imaging parameters PARA(i) are provided, wherein different images IMA(i) are characterized by different imaging parameters PARA(i), e.g. camera positions POS(i) and intrinsic camera parameters CAM(i). I.e. different images IMA(i) represent different perspectives PER(i) onto the object of interest OBJ, i.e. different images IMA(i) have been captured from different camera positions POS(i) and possibly with different intrinsic camera parameters CAM(i). All those imaging parameters PARA(i) for all views PER(i) and, as the case may be, all cameras can be considered to be known from an earlier image capturing step, during which the individual images IMA(i) have been captured from different camera positions POS(i) either by different cameras being positioned at POS(i) or by one camera being moved to the different positions POS(i). While the intrinsic camera parameters CAM(i) might be the same for different images IMA(i), at least the positions POS(i) and perspectives PER(i), respectively, would be different for different images IMA(i). The provided images IMA(i) are then processed in a determination step DCS to determine for each image IMA(i) a respective 2D-3D-correspondence map Ψₚᵣⁱ as well as a respective segmentation mask SEGₚᵣ(i). At least one of the 2D-3D-correspondence maps Ψₚᵣⁱ is further processed in a coarse pose estimation step CPES to determine the initial object pose Tₚᵣ(0).

In some embodiments, indeed only one of the 2D-3D-correspondence maps Ψₚᵣⁱ is further processed in the coarse pose estimation step CPES to determine the initial object pose Tₚᵣ(0). In another embodiment, each one j of the plurality J of the 2D-3D-correspondence maps Ψₚᵣⁱ with j=1, . . . , J and I≥J≥2 is processed in the coarse pose estimation step CPES to determine a respective preliminary object pose T_{pr,j}(0), wherein the initial object pose Tₚᵣ(0) represents an average of the preliminary object poses T_{pr,j}(0).

In the preparation step PS, a dense pose object detector DPOD which is embodied as a trained artificial neural network is applied to determine the 2D-3D-correspondence maps Ψₚᵣⁱ and the segmentation masks SEGₚᵣ(i) from the respective images IMA(i). DPOD, as described in detail in [ZAKHAROV2019], regresses a multi-class object mask and segmentation mask SEGₚᵣ(i), respectively, as well as a dense 2D-3D correspondence map Ψₚᵣⁱ between image pixels of an image IMA(i) and a corresponding 3D model MODOB of the object OBJ depicted in the image IMA(i). Thus, DPOD estimates both a segmentation mask SEGₚᵣ(i) and a dense multi-class 2D-3D correspondence map Ψₚᵣⁱ between an input image IMA(i) and an available 3D model, e.g. MODOBJ, from the image IMA(i).

The coarse pose estimation step CPES applies a Perspective-n-Point approach (PnP), especially supplemented by a random sample consensus approach (RANSAC), to determine a respective initial or preliminary, as the case may be, object pose Tₚᵣ(0), T_{pr,j}(0) from the at least one 2D-3D-correspondence map Ψₚᵣⁱ, Ψₚᵣ^{j}. Given the estimated ID mask, we can observe which objects were detected in the image and their 2D locations, whereas the correspondence map maps each 2D point to a coordinate on an actual 3D model. The 6D pose is then estimated using the Perspective-n-Point (PnP) pose estimation method, e.g. described in [ZHANG2000], that estimates the camera pose given correspondences and intrinsic parameters of the camera. Since a large set of correspondences is generated for each model, RANSAC is used in conjunction with PnP to make camera pose prediction more robust to possible outliers: PnP is prone to errors in case of outliers in the set of point correspondences. RANSAC can be used to make the final solution for the camera pose more robust to such outliers.

In some embodiments, a pose estimation system for refining an initial multi-dimensional pose Tₚᵣ(0) of an object of interest OBJ to generate a refined multi-dimensional object pose Tₚᵣ(NL) with NL≥1 includes a control system configured for executing one or more of the pose estimation methods PEM described above.

As a summary, the objective achieved by the presented solution is to further reduce the discrepancy between performances of the detectors trained on synthetic and on real data by introducing a novel geometrical refining method, building up in the earlier determined initial coarse pose estimation Tₚᵣ(0). In regular operation, the proposed pose refining procedure utilizes the differentiable renderer in the inference phase. It uses multiple views PER(i), POS(i), and PARA(i), respectively, adding relative camera poses POS(i) as constraints to the pose optimization procedure. This is done by comparing the provided Ψₚᵣⁱ and rendered dense correspondences Ψ_{rend}^{k,i} for each image IMA(i) and then transmitting the error back though the differentiable renderer to update the pose Tₚᵣ(k). This assumes the availability of camera positions POS(i) or perspectives PER(i), wherein such poses or perspectives might be relative information, referring to one reference position, e.g. POS(0), or reference perspective, e.g. PER(0). In practice, POS(i) and PER(i), as the case may be, can be easily obtained by a number of various methods, such as placing object on a markerboard and either using an actual multi-camera system or using a single camera but moving the markerboard or the camera. The markerboard will allow to compute camera poses POS(i), PER(i) in the markerboard coordinate system and consequently compute relative poses between the cameras. Moreover, in the scenario of robotic grasping, the robotic arm can be equipped with a camera to observe the object from several viewpoints POS(i). There, one can rely on precise relative poses between them provided by the robotic arm. However, the 6DoF pose of the object in the images stays unknown. Therefore, we aim at estimating the 6DoF object pose in one reference view with relative camera poses used as constraints.

In further summary, a multi-view refinement method is proposed that can be used to significantly improve detectors trained on synthetic data via multi-view pose refinement. In this way, the proposed approach completely avoids use of labeled real data for training.

The elements and features recited in the appended claims may be combined in different ways to produce new claims that likewise fall within the scope of the present disclosure.

The specification provides the following publications to achieve a detailed explanation of the teachings herein and their execution. Each publication is incorporated by reference:
[Barron2019] J. T. Barron, “A general and adaptive robust loss function,” in CVPR, 2019.
[Kingma2014] D. P. Kingma and J. Ba, “Adam: A method for stochastic optimization,” arXiv preprint arXiv:1412.6980, 2014.
[Redmon2016] Joseph Redmon, Santosh Divvala, Ross Girshick, and Ali Farhadi. “You only look once: Unified, real-time object detection”. In CVPR, 2016.
[Redmon2017] Joseph Redmon and Ali Farhadi. Yolo9000: better, faster, stronger. In CVPR, 2017.
[Redmon2018] Joseph Redmon and Ali Farhadi. “Yolov3: An incremental improvement”, arXiv preprint arXiv:1804.02767, 2018.
[Wang2019] He Wang, Srinath Sridhar, Jingwei Huang, Julien Valentin, Shuran Song, and Leonidas J Guibas. “Normalized object coordinate space for category-level 6d object pose and size estimation”. In CVPR, 2019.
[Zakharov2019] Sergey Zakharov, Ivan Shugurov, and Slobodan Ilic. “Dpod: 6d pose object detector and refiner”. In ICCV, 2019.
[Zhou2019] Y. Zhou, C. Barnes, J. Lu, J. Yang, and H. Li, “On the continuity of rotation representations in neural networks,” in CVPR, 2019.
[Zhang2000] Zhengyou Zhang. “A flexible new technique for camera calibration”. IEEE Transactions on pattern analysis and machine intelligence, 22, 2000.

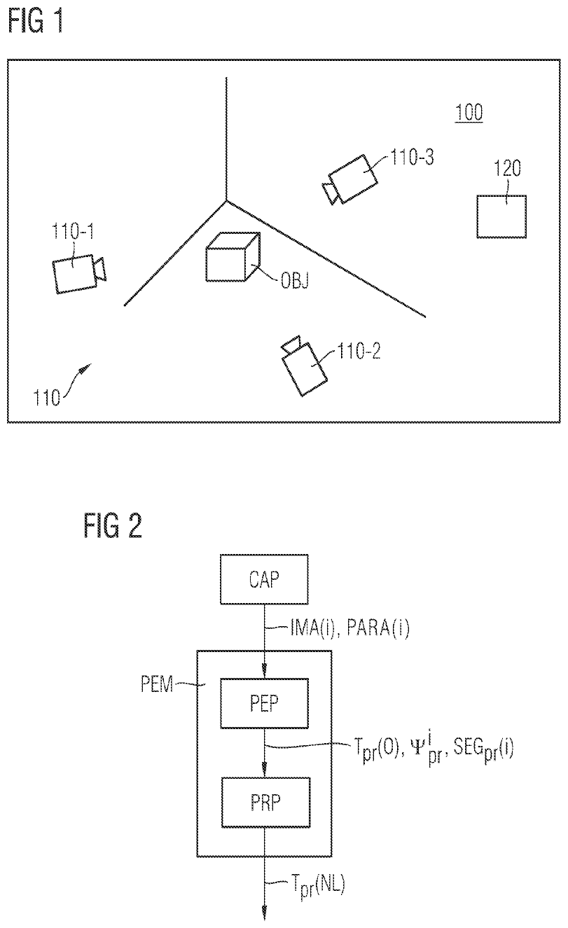

FIG. 1 shows an exemplary real world scene with an object of interest OBJ. The object's OBJ real position in the scene is such that it can be described by a ground truth 6D object pose T_{gt}, including three translational degrees of freedom and coordinates, respectively, as well as three rotational degrees of freedom and coordinates, respectively. However, the real pose T_{gt} is unknown and has to be estimated by a pose estimation system 100 as described herein.

The pose estimation system 100 shown in FIG. 1 comprises a control system 120 for executing the pose estimation method PEM described below and camera system 110 with a plurality of cameras 110-i with i=1, . . . , I and I≥2 which are located at different positions POS(i). In the setup shown in FIG. 1, which is only exemplary, I=3 cameras 110-i are shown. The cameras 110-i are positioned such that they capture images IMA(i) of the scene, therewith depicting the object of interest OBJ. Especially, the cameras 110-i are positioned such that they depict the object OBJ from different perspectives PER(i), e.g. under different viewing angles.

Instead of utilizing a plurality of cameras it would also be possible to use one single camera (not shown) which is movable so that it can be moved to the different positions POS(i) to depict the object from corresponding different perspectives PER(i).

Independent from whether a movable camera or a plurality of cameras is used to capture images IMA(i) from different positions POS(i), the method described in the following assumes that the camera positions POS(i) or perspectives PER(i) are known. Therein, the positions POS(i) can be relative positions, either expressed relative to each other or by selecting one of them, e.g. POS(1), as the reference position POS_{ref} and expressing the remaining positions relative to POS_{ref}. Thus, transformations between camera positions POS(i) are known as well.

In practice, the positions POS(i) can be obtained by a number of various methods, such as placing object on a markerboard and either using an actual multi-camera system or using a single camera but moving the markerboard. A markerboard will allow to compute camera positions POS(i) in the markerboard coordinate system and consequently compute relative poses between the cameras 110-i. In the scenario of robotic grasping, the robotic arm can be equipped with a camera to observe the object from several viewpoints. Therein, one can rely on precise relative poses between them provided by the robotic arm. However, the 6DoF pose of the object in the images stays unknown. Therefore, an estimation of the 6DoF object pose in one reference view with relative camera poses used as constraints is applied.

Moreover, intrinsic camera parameters CAM(i) for capturing a respective image IMA(i) of the object of interest OBJ are known. Therein, “intrinsic camera parameters” is a well-defined term which refers to how the camera projects the 3D scene onto a 2D plane. The parameters include focal lengths, principal point and sometimes distortion coefficients.

As a summary, for each image IMA(i) imaging parameters PARA(i) applied for capturing a respective image IMA(i) are assumed to be known. The imaging parameters PARA(i) include the respective camera position POS(i) and corresponding intrinsic camera parameters CAM(i). For example, parameters PARA(i) can be provided to the control system 120 for further processing with the captured images IMA(i).

The method described in the following moreover uses the availability of a 3D model MODOBJ of the object of interest OBJ, e.g. a 3D CAD model. This can be stored in a corresponding memory of the control system 120 or it can be provided from elsewhere when required.

As shown in FIG. 2, the pose estimation method PEM is subdivided into two procedures, namely an initial pose estimation procedure PEP and a subsequent pose refinement procedure PRP. PEM receives as input at least the images IMA(i), parameters PARA(i), and the model MODOBJ and produces as an output the object pose Tₚᵣ(NL).

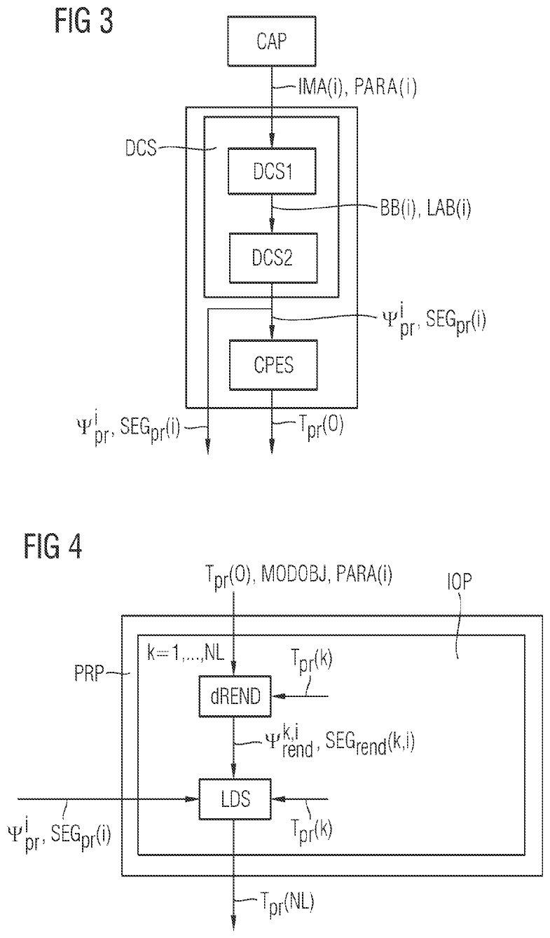

For an initial estimation of the coarse object pose Tₚᵣ(0) of the object of interest OBJ in the initial pose estimation procedure PEP, which shown in FIG. 3, at least one such image IMA(i), e.g. IMA(1), has to be captured in a capturing step CAP with corresponding imaging parameters PARA(1). However, since more than one image IMA(i) with different imaging parameters PARA(i) should be available in the pose refinement procedure PRP, several images IMA(i), still fulfilling i=1, . . . , I and I≥2, are captured in the capturing step CAP. The captured images IMA(i) are processed in a step DCS of determining, for each image IMA(i), a respective segmentation mask SEGₚᵣ(i) as well as a respective 2D-3D-correspondence map Ψₚᵣⁱ between the 2D image IMA(i) and the 3D model MODOBJ of the object of interest OBJ. Step DCS forms the first step of the pose estimation procedure PEP.

Therein, a segmentation mask SEGₚᵣ(i) of an image IMA(i) is a binary 2D matrix with pixel values “1” or “0”, marking the object of interest in the image IMA(i). I.e. only pixels of SEGₚᵣ(i) which correspond to pixels of IMA(i) which belong to the depicted representation of the object OBJ in IMA(i) receive a pixel value “1” in SEGₚᵣ(i).

2D-3D-correspondence maps are described in [Zakharov2019]. A 2D-3D-correspondence map Ψₚᵣⁱ between the pixels of the image IMA(i) and the 3D model MODOBJ directly provides a relation between 2D IMA(i) image pixels and 3D model MODOBJ vertices. For example, a 2D-3D-correspondence map can have the form of a 2D frame, describing a bijective mapping between the vertices of the 3D model of the object OBJ and pixels on the image IMA(i). This provides easy-to-read 2D-3D-correspondences since given the pixel color one can instantaneously estimate its position on the model surface by selecting the vertex with the same color value.

The step DCS of determining, for each image IMA(i), the respective segmentation mask SEGₚᵣ(i) as well as the respective 2D-3D-correspondence map Ψₚᵣⁱ can be executed by a DPOD approach as described in detail in [Zakharov2019]: DPOD is based on an artificial neural network ANN which processes an image IMA(i) as an input to produce a segmentation mask SEGₚᵣ(i) and a 2D-3D-correspondence map Ψₚᵣⁱ. For training of ANN and DPOD, respectively, the network ANN is trained separately for each potential object of interest. To train the network ANN for an object, a textured model MOD of that object is required. The model MOD is rendered in random poses to produce respective images IMAₚₒₛₑ. For each of the rendered images IMAₚₒₛₑ a foreground/background segmentation mask SEGₚₒₛₑ and per-pixel 2D-3D correspondence map Ψₚₒₛₑ is generated. The availability of a 2D-3D correspondence map Ψₚₒₛₑ means that for every foreground pixel in the rendered image IMAₚₒₛₑ it is known which point on the 3D model MOD it corresponds to. Then, the network ANN is trained to take a RGB image and output the segmentation mask SEG and the correspondence map Ψ. This way the network ANN memorizes the mapping from object views to the correct 2D-3D correspondence maps Ψ and can extrapolate that to unseen views.

In some embodiments, the step DCS of determining for each image IMA(i) the respective segmentation mask SEGₚᵣ(i) and the respective 2D-3D-correspondence map Ψₚᵣⁱ can apply a modified DPOD approach, being subdivided into two substeps DCS1, DCS2.

In the first substep DCS1, the provided images IMA(i) are processed to detect a respective object of interest OBJ in the respective image IMA(i) and to output a tight bounding box BB(i) around the detected object OBJ and a corresponding semantic label LAB(i), e.g. an object class, characterizing the detected object. The label LAB(i) is required in the approach described herein because DPOD is trained separately for each object. This means that one DPOD can only predict correspondences for one particular object. Therefore, the object class is needed to choose the right DPOD. DCS1 might apply an approach called “YOLO” as described in [Redmon2016], [Redmon2017], and especially [Redmon2018], i.e. an artificial neural network ANN′ trained to detect an object in an image and to output a corresponding bounding box and label.

The second substep DCS2 of the step DCS of determining, for each image IMA(i), the respective segmentation mask SEGₚᵣ(i) as well as the respective 2D-3D-correspondence map Ψₚᵣⁱ, a DPOD-like architecture DPOD′ can be applied which predicts object masks SEGₚᵣ(i) and dense correspondences Ψₚᵣⁱ from the detections provided by DCS1. I.e. DPOD′ predicts for each pixel the corresponding point on the object's surfaces. Therefore, 2D-3D-correspondences between image pixels and points of the surface of the 3D model are produced.

The two-stage approach of DCS including DCS1 and DCS2 simplifies and accelerates the training procedure of each substep and improves the quality of correspondences Ψₚᵣⁱ, but in essence does not affect the accuracy of the original one-step approach via DPOD.

In some embodiments, in contrast to the DPOD approach described in [Zakharov2019], which utilizes UV mapping, the further optional embodiment applies the 3D normalized object coordinates space (NOCS) as described in [Wang2019]. Each dimension of NOCS corresponds to a uniformly scaled dimension of the object to fit into a [0, 1] range. This parameterization allows for trivial conversion between the object coordinate system and the NOCS coordinate system, which is more suitable for regression with deep learning. A model M can be defined as a set of its vertices v with [symbol] ={v∈ [symbol] }. Furthermore, operators can be defined which compute minimal and maximal values along a vertex dimension DIMi as min_{DIMi}( [symbol] )=min [symbol] and max_{DIMi}( [symbol] )=max [symbol] . Then, for any point px, a NOCS projection operator [symbol] (px) is defined with respect to the model M as

$${π}_{ℳ} ( px ) = \{ \frac{{px}_{x} - {min}_{x} ( ℳ )}{{max}_{x} ( ℳ ) - {min}_{x} ( ℳ )} , \frac{{px}_{y} - {min}_{y} ( ℳ )}{{max}_{y} ( ℳ ) - {min}_{y} ( ℳ )} , \frac{{px}_{z} - {min}_{z} ( ℳ )}{{max}_{z} ( ℳ ) - {min}_{z} ( ℳ )} \}$$

with a corresponding inverse [symbol] .

However, a subsequent coarse pose estimation step CPES of the initial pose estimation procedure PEP provides an initial estimation Tₚᵣ(0) of the object pose. The coarse pose estimation step CPES applies a Perspective-n-Point approach (PnP), e.g. described in [Zhang2000], preferably supplemented by a random sample consensus approach (RANSAC), to determine the initial object pose Tₚᵣ(0) based on an output of the preceding determination step DCS. RANSAC is used in conjunction with PnP to make the estimation of Tₚᵣ(0) more robust to possible outliers. PnP is prone to errors in case of outliers in the set of point correspondences. RANSAC can be used to make the final estimation more robust to such outliers.

In some embodiments of CPES, not all but only one reference map of the plurality I of 2D-3D-correspondence maps Ψₚᵣⁱ provided by DCS is utilized by PnP and RANSAC to determine Tₚᵣ(0), e.g. with i=1.

In some embodiments, not only one but a plurality J with I≥J≥2 of 2D-3D-correspondence maps Ψₚᵣⁱ is selected to be utilized to determine Tₚᵣ⁽⁰⁾. Each selected 2D-3D-correspondence map Ψₚᵣⁱ is processed as described above with PnP and RANSAC to determine a respective preliminary object pose T_{pr,j}(0). The initial object pose Tₚᵣ(0) is then calculated to be an average of the preliminary object poses T_{pr,j}(0).

As an intermediate summary, the initial pose estimation procedure PEP which is completed at this point of the overall pose estimation method PEM comprises the determination step DCS of determining, for each image IMA(i) captured in the upstream image capturing step CAP, the respective segmentation mask SEGₚᵣ(i) as well as the respective 2D-3D-correspondence map Ψₚᵣⁱ and the coarse pose estimation step CPES in which at least one of the 2D-3D-correspondence maps Ψₚᵣⁱ is further processed to determine the initial object pose Tₚᵣ(0). Thus, at this point of the overall pose estimation method PEM a plurality of 2D-3D-correspondence maps Ψₚᵣⁱ, a respective plurality of segmentation masks SEGₚᵣ (i), the initial object pose Tₚᵣ (0), the model MODOBJ, as well as the imaging parameters PARA(i) are available and are provided to the next step of the pose estimation method, i.e. to the pose refinement procedure PRP.

The pose refinement procedure PRP as shown in FIG. 4 and as described in detail below is based on a differentiable renderer dREND. It uses multiple views i adding camera positions POS(i) as constraints to an iterative pose Tₚᵣ(k) optimization procedure with a number NL of loops k=1, . . . , NL based on the optimization of a loss function LF. The procedure compares the 2D-3D-correspondence maps Ψₚᵣⁱ provided by the pose estimation procedure PEP with rendered correspondence maps Ψ_{rend}^{k,i} computed for each i by the differentiable renderer dREND and then transmits an error back though the differentiable renderer dREND to update the object pose from Tₚᵣ(k−1) to Tₚᵣ(k) in terms of object pose updates ΔT, such that Tₚᵣ(k)=ΔT·Tₚᵣ(k−1). The pose refinement procedure PRP first utilizes the initial object pose Tₚᵣ(0). The initial predicted pose Tₚᵣ(0) is then refined in NL≥1 iterations and loops k, so that in the end a refined pose Tₚᵣ(k=NL) is available. The pose refinement is based on an optimization of the discrepancy between provided correspondence maps Ψₚᵣⁱ and related rendered correspondence map Ψ_{rend}^{k,i} for each i. The rendered correspondence maps Ψ_{rend}^{k,i} and, correspondingly, the discrepancy directly depend on the assumed object pose Tₚᵣ(k) so that a variation of the object pose Tₚᵣ(k) leads to a variation of the discrepancy, such that a minimum discrepancy can be considered to be an indicator for correctness of the assumed object pose Tₚᵣ(NL).

Thus, the pose refinement procedure PRP estimates the refined object pose Tₚᵣ(NL) by an iterative optimization procedure IOP of a loss. The loss is according to the given loss function LF(k) and depends on discrepancies between the provided 2D-3D-correspondence maps Ψₚᵣⁱ and respective rendered 2D-3D-correspondence maps Ψ_{rend}^{k,i}. Thus, for every provided 2D-3D-correspondence map Ψₚᵣⁱ a respective rendered 2D-3D-correspondence map Ψ_{rend}^{k,i} is required, so that a comparison becomes possible. Such correspondence maps Ψₚᵣⁱ, Ψ_{rend}^{k,i} might be considered to be assigned to each other and have in common that they both relate to the same image IMA(i), position POS(i), perspective PER(i), and imaging parameters PARA(i), respectively, indicated by the common parameter “i”.

In some embodiments, the iterative optimization procedure IOP might end at k=NL when the corresponding loss function LF, which depends on Tₚᵣ(k) and ΔT, respectively, converges or falls under a given threshold or similar. I.e. NL is not pre-defined but depends on the variation of Tₚᵣ(k) and the resulting outcome of the loss function LF. General criteria for ending an iterative optimization procedure of a loss function as such are known. However, the object pose Tₚᵣ(NL) achieved in loop k=L is finally assumed to be the aspired, refined object pose.

In more detail, a starting point of the pose refinement procedure PRP in each loop k of the iterative optimization procedure IOP would be the rendering of a rendered 2D-3D-correspondence map Ψ_{rend}^{k,i} and of a segmentation map SEG_{rend} (k, i) for each i. Such rendering is achieved by the differentiable renderer dREND mentioned above. Therein, the differentiable renderer dREND can be a differentiable implementation of a standard renderer, e.g. known from computer graphics applications. For example, such differentiable renderer takes a textured object model, an object's pose, light courses, etc. and produces a corresponding image. In contrast to standard rendering, a differentiable renderer allows to define any function over the image and to compute its derivatives w.r.t. all the renderer inputs, e.g. a textured object model, an object's pose, light courses, etc. as mentioned above. In such a way, it is possible to directly update the object, its colors, its position, etc. in order to get the desired rendered data set.

In each loop k, starting with k=1, the differentiable renderer dREND requires as an input an assumed object pose Tₚᵣ(k), the 3D model MODOBJ of the object of interest OBJ, and the imaging parameters PARA(i), especially the camera position POS(i) and the intrinsic parameters CAM(i). In that loop k, the differentiable renderer dREND produces as an output the rendered 2D-3D-correspondence map Ψ_{rend}^{k,i} and the segmentation map SEG_{rend}(k, i) for each respective i from the provided input. I.e. given the 3D model MODOBJ, camera position POS(i), corresponding intrinsic camera parameters CAM(i), and Tₚᵣ(k) it is possible to compute which vertex of the 3D model MODOBJ would be projected on which pixel of a rendered 2D image. This correspondence is expressed by a respective 2D-3D-correspondence map Ψ_{rend}^{k,i}. Such process is deterministic and errorless and can be executed by the differentiable renderer dREND. The resulting correspondence map Ψ_{rend}^{k,i} exactly corresponds to the model MODOBJ in the given pose Tₚᵣ(k) from the perspective PER(i) of the respective camera position POS(i) and can be compared to the respective provided 2D-3D-correspondence map Ψₚᵣⁱ.

The assessment whether an object pose Tₚᵣ(k) assumed in loop k is sufficiently correct happens in a loss determination step LDS based on the determination of the per pixel (x, y) loss function LF(k), wherein LF(k) is defined as

$$LF ( k ) = \frac{1}{I} {\sum }_{i = 1}^{I} L ( {T}_{pr} ( k ) , {SEG}_{pr} ( i ) , {SEG}_{rend} ( k , i ) , {Ψ}_{pr}^{i} , {Ψ}_{rend}^{k , i} )$$

with summands

$$L ( {T}_{pr} ( k ) , {SEG}_{pr} ( i ) , {SEG}_{rend} ( k , i ) , {Ψ}_{pr}^{i} , {Ψ}_{rend}^{k , i} ) = \frac{1}{N} {\sum }_{( x , y ) ∈ {SEG}_{pr} ( i ) ⋂ {SEG}_{rend} ( k , i )} ρ ( {π}_{ℳ}^{- 1} ( {Ψ}_{pr}^{i} ( x , y ) ) , {π}_{ℳ}^{- 1} ( {Ψ}_{rend}^{k , i} ( x , y ) ) )$$

Therein, I expresses the number of provided 2D-3D-correspondence maps Ψₚᵣⁱ, x, y are pixel coordinates in the correspondence maps Ψₚᵣⁱ, Ψ_{rend}^{k,i}, SEGₚᵣ(i)∩SEG_{rend}(k, i) is the group of intersecting points of provided Ψₚᵣⁱ and rendered correspondence maps Ψ_{rend}^{k,i}, expressed by the corresponding segmentation masks SEGₚᵣ(i), SEG_{rend}(k, i), N is the number of such intersecting points of provided Ψₚᵣⁱ and rendered correspondence maps Ψ_{rend}^{k,i}, expressed by the corresponding segmentation masks SEGₚᵣ(i), SEG_{rend}(k, i), and ρ stands for an arbitrary distance function in 3D. There are numerous possible ways to implement the distance function ρ: [symbol] × [symbol] →R⁺. As the provided Ψₚᵣⁱ and rendered correspondence maps Ψ_{rend}^{k,i} might contain a potentially large number of outliers, a robust function must be used to mitigate the problem. For example, the general robust function introduced in [Barron2019] qualifies. Moreover, the continuous rotation parameterization from [Zhou2019] can be applied used. This parameterization enables faster and more stable convergence during the optimization procedure. [symbol] (px) and its inverse [symbol] represent the NOCS transformation introduced above.

Actually, the loss function LF describes a pixel-wise comparison of Ψₚᵣⁱ and Ψ_{rend}^{k,i} and the pixel-wise difference is minimized across the loops k of the iterative optimization procedure IOP.

Therein, the object pose Tₚᵣ(k) assumed in loop k is selected such that Tₚᵣ(k) differs from the assumed object pose Tₚᵣ(k−1) of the preceding loop k−1, wherein the iterative optimization procedure IOP applies a gradient-based method for the selection, wherein the loss function LF is minimized in terms of object pose updates ΔT, such that Tₚᵣ(k)=ΔT·Tₚᵣ(k−1). I.e. the loss function LF(k) is minimized iteratively across loops k by gradient descent over the object pose update ΔT. This could be done with any gradient-based methods, such as [Kingma2014]. Convergence might be achieved within, for example, 50 optimization steps, i.e. NL=50.

In general, the describes approach allows accurate 6DoF pose estimation, even in a monocular case in which only one image IMA(i) with I=1 and correspondingly only one rendered correspondence map Ψ_{rend}^{k,i} is utilized. Any imprecision in pose estimation, which is not visible in the monocular case, will easily be seen when the object OBJ is observed from a different perspective PER(j).

For example, during the pose refinement procedure PRP only a single transformation is optimized, namely the reference pose Tₚᵣ. For each image in the set of calibrated cameras, object pose is transformed from the coordinate system of a reference image, e.g. IMA(1), to the coordinate system of each particular camera CAM(i) using the known relative camera positions POS(i). Given a vertex v∈ [symbol] in the model coordinate system, it is transformed to the i-th camera CAM(i) coordinate system via v_{C}_{ᵢ}=Pᵢ^{rel}·Tₚᵣ·\tilde{v}.

Respectively, the transformation Pᵢ^{rel}·Tₚᵣ is used by the renderer dREND to render SEG_{rend}(i) and Ψ_{rend}^{k,i} for the i-th image IMA(i). Loss in each frame is then used to compute gradients through the renderer dREND in order to compute a joint update Tₚᵣ(k)=ΔT·Tₚᵣ(k−1).

The teachings of this disclosure may further overcome discrepancies between performance of detectors trained on synthetic and on the real data. Following the dense correspondence paradigm of DPOD, the DPOD detector is trained only on synthetically generated data. The introduced pose refinement procedure PRP is based on the differentiable renderer dREND in the inference phase. Herein, the refinement procedure is extended from a single view with I=1 to multiple views with I>1, adding relative camera poses POS(i) as constraints to the iterative optimization procedure IOP. In practice, relative camera poses POS(i) can be easily obtained by placing the object of interest on the markerboard and either using an actual multi-camera system or using a single camera but moving the markerboard or the camera. The markerboard will allow to compute camera poses in the markerboard coordinate system and consequently compute relative poses between the cameras. In reality, this scenario is easy to imagine for robotic grasping where the robotic arm equipped with the camera can observe the object from several viewpoints. There, one can rely on precise relative poses provided by the robotic arm. The 6DoF pose of the object in the images stays unknown. Therefore, we aim at estimating the 6 DoF object pose in one reference view with relative camera poses used as constraints.

What is claimed is:

1. A pose estimation method for refining an initial multi-dimensional pose of an object of interest to generate a refined multi-dimensional object pose Tₚᵣ(NL) with NL≥1, the method comprising:
providing the initial object pose Tₚᵣ(0) and at least one 2D-3D-correspondence map Ψₚᵣⁱ with i=1, . . . , I and I≥1; and
estimating the refined object pose Tₚᵣ (NL) using an iterative optimization procedure of a loss according to a given loss function LF(k) based on discrepancies between the one or more provided 2D-3D-correspondence maps Ψₚᵣⁱ and one or more respective rendered 2D-3D-correspondence maps Ψ_{rend}^{k,i}.

2. A method according to claim 1, wherein:
the loss function LF is defined as a per-pixel loss function over provided correspondence maps Ψₚᵣⁱ and rendered correspondence maps Ψ_{rend}^{k,i};
the loss function LF(k) relates the per-pixel discrepancies of provided correspondence maps Ψₚᵣⁱ and respective rendered correspondence maps Ψ_{rend}^{k,i} to the 3D structure of the object and its pose Tₚᵣ(k); and
the rendered correspondence maps Ψ_{rend}^{k,i} depend on an assumed object pose Tₚᵣ(k) and the assumed object pose Tₚᵣ(k) is varied in the loops k of the iterative optimization procedure.

3. A method according to claim 1, wherein:
the iterative optimization procedure comprises NL≥1 iteration loops k with k=1, . . . , NL;
in each iteration loop k
an object pose Tₚᵣ(k) is assumed, and
a renderer renders one respective 2D-3D-correspondence map Ψ_{rend}^{k,i} for each provided 2D-3D-correspondence map Ψₚᵣⁱ, utilizing as an input:
a 3D model of the object of interest,
the assumed object pose Tₚᵣ(k), and a
n imaging parameter PARA(i) which represents one or more parameters of capturing an image IMA(i) underlying the respective provided 2D-3D-correspondence map Ψₚᵣⁱ.

4. A method according to claim 3, wherein:
the assumed object pose Tₚᵣ(k) of loop k of the iterative optimization procedure is selected such that Tₚᵣ(k) differs from the assumed object pose Tₚᵣ(k−1) of the preceding loop k−1;
the iterative optimization procedure applies a gradient-based method for the selection; and
the loss function LF is minimized in terms of object pose updates ΔT, such that Tₚᵣ(k)=ΔT·Tₚᵣ(k−1).

5. A method according to claim 3, wherein:
in each iteration loop k a segmentation mask SEG_{rend}(k, i) is obtained by the renderer for each one of the respective rendered 2D-3D-correspondence maps Ψ_{rend}^{k,i}, which segmentation masks SEG_{rend}(k, i) correspond to the object of interest OBJ in the assumed object pose Tₚᵣ(k); and
each segmentation mask SEG_{rend}(k, i) is obtained by rendering the 3D model using the assumed object pose Tₚᵣ(k) and imaging parameter PARA(i).

6. A method according to claim 5, wherein:
the loss function LF(k) is defined as a per pixel loss function in a loop k of the iterative optimization procedure;
$$LF ( k ) = \frac{1}{I} {\sum }_{i = 1}^{I} L ( {T}_{pr} ( k ) , {SEG}_{pr} ( i ) , {SEG}_{rend} ( k , i ) , {Ψ}_{pr}^{i} , {Ψ}_{rend}^{k , i} )$$
$$with$$
$$L ( {T}_{pr} ( k ) , {SEG}_{pr} ( i ) , {SEG}_{rend} ( k , i ) , {Ψ}_{pr}^{i} , {Ψ}_{rend}^{k , i} ) = \frac{1}{N} {\sum }_{( x , y ) ∈ {SEG}_{pr} ( i ) ⋂ {SEG}_{rend} ( k , i )} ρ ( {π}_{ℳ}^{- 1} ( {Ψ}_{pr}^{i} ( x , y ) ) , {π}_{ℳ}^{- 1} ( {Ψ}_{rend}^{k , i} ( x , y ) ) ) ;$$
and
I expresses the number of provided 2D-3D-correspondence maps Ψₚᵣⁱ,
x, y are pixel coordinates in the correspondence maps Ψₚᵣⁱ, Ψ_{rend}^{k,i},
p stands for a distance function in 3D,
SEGₚᵣ(i)∩SEG_{rend}(k, i) is the group of intersecting points of predicted and rendered correspondence maps Ψₚᵣⁱ, Ψ_{rend}^{k,i}, expressed by the corresponding segmentation masks SEGₚᵣ(i), SEG_{rend}(k, i),
N is the number of such intersecting points of predicted and rendered correspondence maps Ψₚᵣⁱ, Ψ_{rend}^{k,i}, and [symbol]
is an operator for transformation of the respective argument into a suitable coordinate system.

7. A method according to claim 3, wherein the renderer comprises a differentiable renderer.

8. A method according to claim 1, further comprising determining the initial object pose Tₚᵣ(0) of the object of interest by:
providing a number of images IMA(i) of the object of interest with i=1, . . . , I and I≥2 as well as known imaging parameters PARA(i), wherein different images IMA(i) are characterized by different imaging parameters PARA(i),
processing the provided images IMA (i) to determine for each image IMA(i) a respective 2D-3D-correspondence map Ψₚᵣⁱ as well as a respective segmentation mask SEGₚᵣ (i); and
further processing at least one of the 2D-3D-correspondence maps Ψₚᵣⁱ in a coarse pose estimation step CPES to determine the initial object pose Tₚᵣ(0).

9. A method according to claim 8, further comprising processing one of the plurality J of the 2D-3D-correspondence maps Ψₚᵣⁱ with j=1, . . . , J and I≥J≥2 to determine the initial object pose Tₚᵣ(0).

10. A method according to claim 8, further comprising processing each one j of a plurality J of the 2D-3D-correspondence maps Ψₚᵣ^{j} with j=1, . . . , J and I≥J≥2 to determine a respective preliminary object pose T_{pr,j} (0), wherein the initial object pose Tₚᵣ(0) represents an average of the preliminary object poses T_{pr,j} (0).

11. A method according to claim 8, further comprising applying a dense pose object detector comprising a trained artificial neural network in the preparation step PS to determine the 2D-3D-correspondence maps Ψₚᵣⁱ and the segmentation masks SEGₚᵣ(i) from the respective images IMA(i).

12. A method according to claim 8, wherein coarse pose estimation includes applying a Perspective-n-Point approach supplemented by a random sample consensus approach to determine a respective object pose Tₚᵣ(0), T_{pr,j}(0) from the at least one 2D-3D-correspondence map Ψₚᵣⁱ, Ψₚᵣ^{j}.

13. A pose estimation system for refining an initial multi-dimensional pose Tₚᵣ(0) of an object of interest to generate a refined multi-dimensional object pose Tₚᵣ (NL) with NL≥1, the system comprising a control system programmed to:
provide the initial object pose Tₚᵣ(0) and at least one 2D-3D-correspondence map Ψₚᵣⁱ with i=1, . . . , I and I≥1; and
estimating the refined object pose Tₚᵣ(NL) using an iterative optimization procedure of a loss according to a given loss function LF(k) based on discrepancies between the one or more provided 2D-3D-correspondence maps Ψₚᵣⁱ and one or more respective rendered 2D-3D-correspondence maps Ψ_{rend}^{k,i}.
